(19) United States
(12) Patent Application Publication
(10) Pub. No.: US 2026/0011056 A1
(43) Pub. Date: Jan. 8, 2026

(54) IMPLEMENTING PORTRAIT EDITING USING A MACHINE LEARNING MODEL

(71) Applicant: Lemon Inc., Grand Cayman (KY)

(72) Inventors: Tiancheng Zhi, Los Angeles, CA (US); Bowei Chen, Los Angeles, CA (US); Peihao Zhu, Los Angeles, CA (US); Shen Sang, Los Angeles, CA (US); Jing Liu, Los Angeles, CA (US); Linjie Luo, Los Angeles, CA (US)

(21) Appl. No.: 18/763,728

(22) Filed: Jul. 3, 2024

(51) Int. Cl. G06T 11/60; G06T 5/60

(52) U.S. Cl. CPC G06T 11/60; G06T 5/60

(57) ABSTRACT

The present disclosure describes techniques for implementing portrait editing using a machine learning model. An and a text prompt are input into a first machine learning model. The image comprises a portrait of a subject. The text prompt indicates a target result of editing the image. The first machine learning model is trained to perform portrait editing while preserving untargeted features. An editing mask is generated by the first machine-learning model based on the image. The editing mask indicates a first area for editing and a second area for preserving original content of the image. A mask-guided predicted noise is computed at each timestep and a process of editing the image is guided by the first machine learning model based on the editing mask. An edited image is generated by the first machine learning model. The edited image comprises the target editing result and retains detailed features of the subject.

### BACKGROUND

Machine learning models are increasingly being used across a variety of industries to perform a variety of different tasks. Such tasks may include content generation. Improved techniques for utilizing machine learning models for content generation are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for implementing portrait editing using a machine learning model in accordance with the present disclosure.

FIG. 2 shows an example system for training a machine learning model in accordance with the present disclosure.

FIG. 3 shows another example system for training a machine learning model in accordance with the present disclosure.

FIG. 4 shows an example process for implementing portrait editing using a machine learning model in accordance with the present disclosure.

FIG. 5 shows an example process for training a machine learning model in accordance with the present disclosure.

FIG. 6 shows an example process for training a machine learning model in accordance with the present disclosure.

FIG. 7 shows an example process for training a machine learning model in accordance with the present disclosure.

FIG. 8 shows an example process for training a machine learning model in accordance with the present disclosure.

FIG. 9 shows an example process for training a machine learning model in accordance with the present disclosure.

FIG. 10 shows an example process for training a machine learning model in accordance with the present disclosure.

FIG. 11 shows an example process for training a machine learning model in accordance with the present disclosure.

FIG. 12 shows an example process for training a machine learning model in accordance with the present disclosure.

FIG. 13 shows example quantitative evaluation results in accordance with the present disclosure.

FIG. 14 shows an example computing device which may be used to perform any of the techniques disclosed herein.

### DETAILED DESCRIPTION OF ILLUSTRATIVE EMBODIMENTS

Portrait editing is increasingly popular in a variety of different applications, including photography and social media. In many of these applications, users can select from a set of pre-defined editing options and then apply chosen edits to their own photos. In practice, the key requirement of portrait editing is to deliver outcomes that achieve selected editing while strictly preserving the features of subjects that the user intends to remain unaltered (e.g., identity and clothing for expression editing). Even slight deviations in these features can markedly affect the perceived quality of the outcome.

Existing image editing approaches fail to satisfy the requirements of portrait editing tasks. Some existing image editing techniques struggle to achieve desired editing results. The existing image editing techniques also fail to preserve detailed subject features. Other existing image editing techniques require extremely high-quality training datasets, which are difficult to collect. As such, improved techniques for portrait editing are needed.

Described herein are improved techniques for implementing portrait editing using a machine learning model. A machine learning model can be trained using a synthetic dataset that can be generated automatically at low cost, thereby eliminating the necessity of manually collecting datasets. The synthetic dataset can be generated for any user-defined edits and can be used for the machine learning model to effectively learn the editing directions, thereby fulfilling the aforementioned requirements and upholding high image quality. More specifically, the synthetic dataset described herein can be generated using a conditional dataset generation strategy that produces diverse, paired data given text prompts. Such paired data has better identity and layout alignment than training data produced using existing data generation strategies.

The training data can be used to train a machine learning model, e.g., a Multi-Conditioned Diffusion Model (MCDM), to effectively learn editing directions and preserve subject features. The conditional signals from an input image and text prompt can be injected into the diffusion model. The trained machine learning model can explicitly identify regions expected to change (e.g., face regions for expression editing), producing an editing mask. The editing mask can provide guidance for the inference process to further keep subject features untouched.

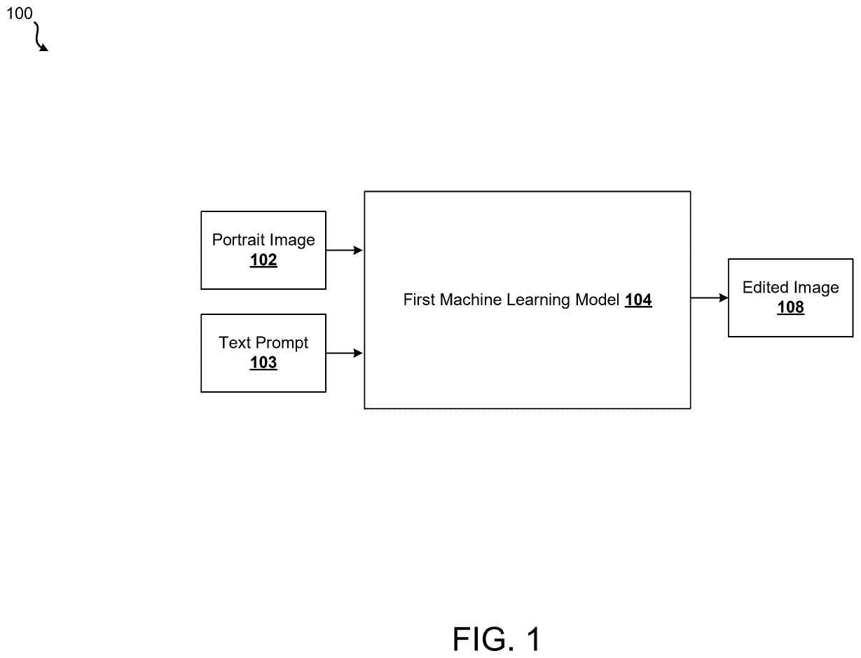

FIG. 1 shows an example system 100 for implementing portrait editing using a first machine learning model 104. A portrait image 102 and a text prompt 103 can be input into the first machine learning model 104. The portrait image 102 can be an image that comprise a portrait of a subject. The text prompt 103 can indicate a target result of editing the portrait image 102. For example, the text prompt 103 can indicate one or more ways in which a user wants the portrait image 102 to be edited. The first machine learning model 104 can be trained to perform portrait editing while preserving untargeted features.

In embodiments, the first machine learning model 104 can generate an editing mask. The first machine learning model 104 can generate an editing mask based on the portrait image 102. The editing mask can indicate a first area in the portrait image 102 for editing. The editing mask can indicate a second area in the portrait image 102 for preserving original content of the portrait image 102. The editing mask can provide guidance for the first machine learning model 104 during the inference process to keep certain features of the portrait image 102 (e.g., those features in the second area) untouched. The first machine learning model 104 can compute a mask-guided predicted noise at each timestep. A process of editing the portrait image 102 by the first machine learning model can be guided based on the editing mask.

An edited image 108 can be generated by the first machine learning model 104. The edited image 108 can be generated by the first machine learning model 104 based on the portrait image 102 and the text prompt 103. The edited image 108 can depict the target editing result (e.g., the target result of editing the portrait image 102 as described in the text prompt 103). The edited image 108 can retain detailed features of the subject in the portrait image 102.

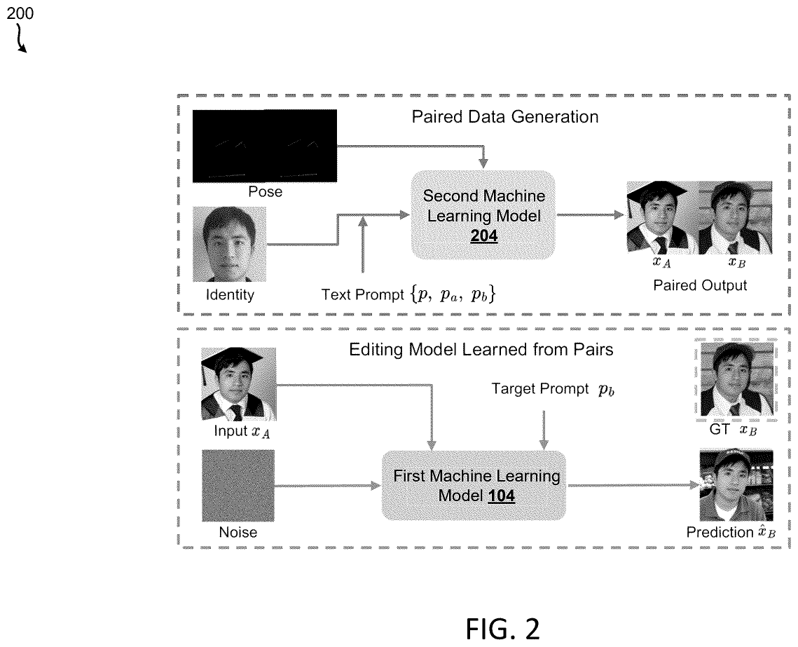

FIG. 2 shows an example system 200 for generating training pairs by a second machine learning model and training the first machine learning model 104 on the generated training pairs in accordance with the present disclosure. The first machine learning model 104 can be trained using training pairs. The training pairs can be generated by a second machine learning model 204. For example, the training pairs, such as the paired output (x_{A}, x_{B}), can be generated by the second machine learning model 204 using composable diffusion conditioning on both pose information and identity information.

The second machine learning model 204 can produce training pairs aligned with any specified editing directions (e.g., from a graduation hat to a flat cap hat) defined by text prompts. But generating pairs with perfect spatial and identity alignment is very challenging. Thus, it is desirable to generate reasonably good pairs, meeting three essential criteria: (1) the user identity in x_{A} (i.e., source image to be used as input during a training process) and x_{B} (target image to be use as ground truth during the training process) should match as closely as possible; (2) x_{A} and x_{B} should have rough spatial alignment; (3) the data should cover a diverse range of user appearances (for better generalization).

The second machine learning model 204 can utilize a conditional pair generation strategy built on top of composable diffusion to meet the three requirements outlined above. The second machine learning model 204 can generate x_{A} and x_{B} within a single image through a single denoising process. This helps generate consistent identities in x_{A} and x_{B} (criterion 1). To ensure that the second machine learning model 204 can generate x_{A} and x_{B} within a single image through the single denoising process, pretrained stable diffusion can be employed in conjunction with the composable diffusion to generate an image x=[x_{A}, x_{B}]∈R^{H×2W×3}, where the operator [⋅, ⋅] represents the horizontal concatenation of two images. H and W denote the height and width of x_{A} and x_{B}.

The second machine learning model 204 can incorporate pose information to improve spatial alignment (criterion 2). The second machine learning model 204 can extract identity information from real photos and use this information to ensure criterion 1 and 3. Further, criteria 2 and 3 can be implemented as conditions to guide the denoising process of x. Specifically, a latent code z_{T}∈R^{h×2w×4} can be randomly initialized, where h=H/8, w=W/8, and 4 represents the feature dimension of the latent code. At each timestep t, the predicted noise can be computed by combining three classifier-free guidance results:

$$\overline{ϵ} = {s}_{d}^{′} \cdot {{ϵ}^{`}}_{{θ}^{′}} ( {z}_{t} , t \{ {c}_{p} , {c}_{id} \} ) + {s}_{a}^{′} \cdot {M}_{a}^{′} ⊙ {{ϵ}^{`}}_{{θ}^{′}} ( {z}_{t} , t \{ {c}_{{p}_{a}} , {c}_{id} \} ) + {s}_{b}^{′} \cdot {M}_{b}^{′} ⊙ {{ϵ}^{`}}_{{θ}^{′}} ( {z}_{t} , t \{ {c}_{{p}_{b}} , {c}_{id} \} ) ,$$

where cₚ, cₚ_{ₐ}, and cₚ_{_{b}} represent text embeddings computed from the shared prompt p, the source prompt pₐ, and the target prompt p_{b}, respectively. In the example of FIG. 2, p is “the same man on the left and right”, pₐ is “a man, graduation hat”, and p_{b} is “a man, flat cap hat.” c_{id} denotes identity embeddings extracted from a real-world portrait image using a variant of CLIP-based identity encoder. This encoder translates an image into multiple textual word embeddings, thus can be combined with cₚ, cₚ_{ₐ}, and cₚ_{_{b}} to provide identity information for the denoising process.

The matrices

$${M}_{a}^{′} and {M}_{b}^{′}$$

are defined as [1, 0] and [0, 1] respectively, both belonging to R^{h×2w×4}. Here, 1 (0) represents a matrix in the dimension h×w×4 with all values set to one (zero). Additionally, the variables

$${s}_{d}^{′} , {s}_{a}^{′} , and {s}_{b}^{′}$$

signify the strengths associated with each predicted noise. Further, the denoising process is guided by a pose image as shown in the top left of FIG. 2. This pose image ensures alignment by featuring the same pose in both the left and right parts of the image. The pair generated by our approach is depicted as (x_{A}, x_{B}) in FIG. 2. Notably, both the pose image and the real-world portrait image from which identity embeddings being extracted play a crucial role in generating good pairs.

The first machine learning model 104 can be trained on the training pairs generated by the second machine learning model 204. By leveraging multiple conditions in different ways, the first machine learning model can effectively learn any editing direction from the training pairs, while preserving detailed subject features that are not supposed to be changed. During inference, the trained first machine learning model 104 can generate desired editing results by automatically generating an editing mask to further preserve subject details in the input portrait image.

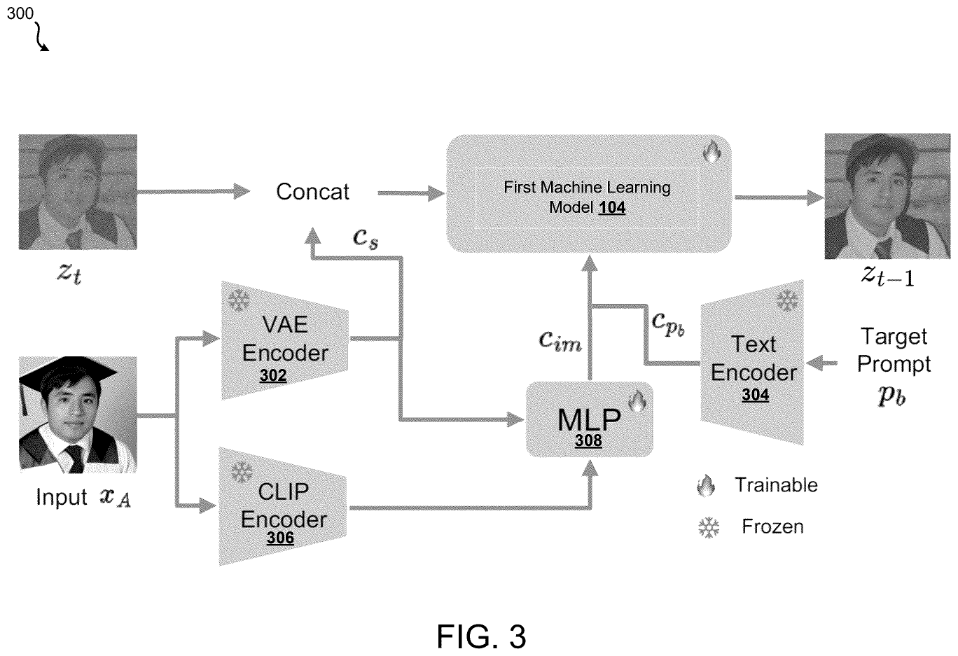

FIG. 3 shows an example system 300 for training the first machine learning model in accordance with the present disclosure. Although the generated training pairs are reasonably good, they are still not perfect. For example, in FIG. 2, the face in x_{B} is slightly wider than that in x_{A}. The imperfection can potentially confuse the first machine learning model 104 and harm the performance. Therefore, given these imperfect pairs, the first machine learning model 104 can be configured to effectively learn pertinent information, such as editing direction and preservation of untargeted subject features, from the generated training pairs while simultaneously filtering out unexpected noise—specifically, small variations in identity and layout. The first machine learning model 104 is configured to integrate various conditions into the stable diffusion architecture in distinct ways. Both image and text embeddings can be injected into the first machine learning model 104 in different ways to effectively learn the editing direction and preserve subject features.

The first machine learning model 104, which can be represented as ϵ_{θ}(zₜ,t{cₛ,cᵢₘ,cₚ_{_{b}}}), at timestep t, considers three pathways of conditional signals: (1) spatial embeddings cₛ=E(x_{A}), extracted by a VAE encoder 302 from input image x_{A}, (2) text embeddings cₚ_{_{b}}, extracted by a pretrained stable diffusion text encoder 304 with target text prompt p_{b} as input, (3) image embeddings cᵢₘ=MLP([E(x_{A}), CLIPᵢₘ(x_{A})]), where CLIPᵢₘ(⋅) denotes embeddings extracted from the pretrained CLIP image encoder 306 with x_{A} as input. The MLP 308 is a multi-layer perceptron that projects image embeddings to the space of text embeddings.

To incorporate these embeddings into the first machine learning model 104, the following modifications can be made to the stable diffusion architecture: (1) To prevent the imperfections in x_{B} from misleading the model into generating an output \hat{x}_{B} that alters the layout and identity in x_{A}, the spatial embeddings cₛ can be concatenated with the noisy latent zₜ. The resulting concatenation can then be utilized as the input for the U-Net. Architecturally, the first layer of the U-Net encoder can be adjusted to accommodate an additional four channels (for cₛ), increasing the total to eight channels. (2) cₚ_{_{b}} and cᵢₘ can be concatenated and fed into the cross-attention layer, akin to the stable diffusion architecture. Functionally, cₚ_{_{b}} includes crucial information about the target domain as instructed by the text prompt, steering the output \hat{x}_{B} towards the desired domain B. Simultaneously, cᵢₘ contributes visual information derived from the input image to the cross-attention layer, offering visual guidance in the attention mechanism. This prevents \hat{x}_{B} from strictly adhering to the text instruction, ensuring that the output remains connected to the visual context of x_{A} and preventing undue deviation.

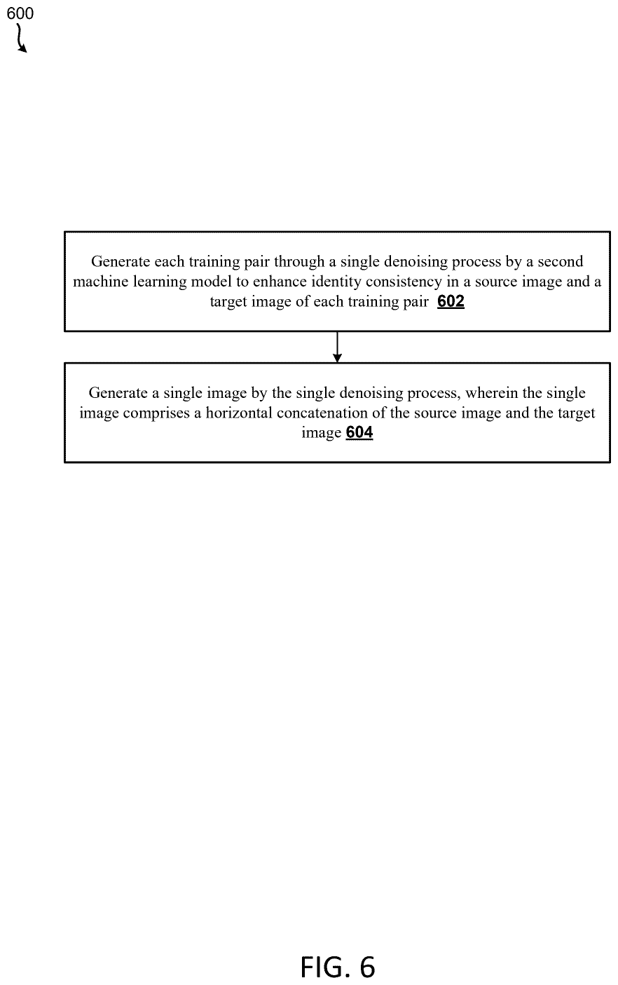

The network weights can be initialized with pretrained stable diffusion. During the training process, cₚ_{_{b}} can be replaced with cₚ_{ₐ} and x_{B} can be replaced with x_{A} by a redetermined percentage of time during training, such as 5% of the time. This enables the first machine learning model 104 to reconstruct input images (e.g., perform identical editing), which can be utilized during the inference phase for mask generation. A dropout mechanism for multiple signals can be implemented for classifier-free guidance. For example, with a 20% probability, any combination of cₛ, cᵢₘ, cₚ, or even all of them can be dropped. FIGS. 6(a)-(f), discussed below in more detail, illustrate the ablation of these design choices, underscoring the effectiveness of employing all conditional signals simultaneously.

Text prompts can be employed to create the training pair (x_{A}, x_{B}) using a pre-trained stable diffusion model and an image editing technique. However, this method often results in unsatisfactory x_{B} as it fails to preserve the identity in x_{A}.

Both incorporating pose information to improve spatial alignment and extracting identity information from real photos play a crucial role in generating good pairs. Dropping either the pose information or the identity information results in considerable spatial misalignment and noticeable differences in facial shape, as compared to the training pair that is generated by the second machine learning model 204.

As described above, the second machine learning model 204 can utilize a conditional pair generation strategy built on top of composable diffusion to generated improved training pairs that satisfy the following criteria: (1) the user identity in x_{A} and x_{B} matches closely; (2) x_{A} and x_{B} have rough spatial alignment. The second machine learning model 204 can generate x_{A} and x_{B} within a single image achieved through a single denoising process. This helps generate consistent identities in x_{A} and x_{B}.

The training pairs generated by the second machine learning model 204 should cover a diverse range of user appearances. This is crucial for enhancing generalization ability. Outputs generated by a machine learning model trained on a dataset with less diverse identities show inconsistent identity with the input image. Conversely, training a machine learning model (e.g., the first machine learning model 104) on a dataset with diverse identities yields the desired editing outcome, demonstrating that the machine learning model trained with diverse identities has better generalization ability.

As discussed above, a dropout mechanism for multiple signals can be implemented for classifier-free guidance. More specifically, with a 20% probability, any combination of the following can be dropped: cₛ, cᵢₘ, and cₚ.

Training a machine learning model from scratch yields the poorest image quality, due to the absence of image generation priors and text prompt interpretation. Dropping spatial embeddings fails to preserve spatial layout and some image details, such as the person's hairstyle. Excluding image embeddings causes “over-editing” towards the target domain, compromising image fidelity. Without classifier-free guidance, less expressive edits emerge. In contrast, a full pipeline, where a machine learning model (e.g., the first machine learning model 104) considers all three pathways of the conditional signals: spatial embeddings, text embeddings, and image embeddings, produces the best editing results.

After training, the standard approach for generating predictions x_{B} from x_{A} involves denoising a random latent z_{T} over T iterations using the trained model (with classifier-free guidance). While the generated x_{B} successfully accomplishes the desired edits while preserving identity and layout, challenges may persist in retaining specific details of the subject's features. Standard image generation, without mask-guided editing, can alter details (e.g., patterns on hats and upper clothing) in the input image.

To enhance the preservation of these details, a mask can be derived from the trained first machine learning model 104, providing explicit guidance for the denoising process. This mask indicates areas for editing and those to be left untouched. DiffEdit can be adapted to automatically generate such a mask. The key difference between the mask described herein and DiffEdit's mask generation strategy is that, instead of relying on a pretrained Stable Diffusion model, the trained first machine learning model 104 with its reconstruction capabilities is leveraged to achieve more precise mask generation. By applying DiffEdit to the trained first machine learning model 104 instead of the original Stable Diffusion model, more precise mask generation can be achieved due to the first machine learning model 104's reconstruction capability. This more precise mask generation underscores the first machine learning model 104's capacity to discern the types of content that should be edited, even by training on an imperfect dataset.

Once we have the mask M, at each timestep t, we calculate the mask-guided predicted noise by:

$$\hat{ϵ} = {{ϵ}^{`}}_{θ} ( {z}_{t} , t \{ {c}_{s} , {c}_{im} , {c}_{{p}_{b}} \} ) ⊙ M + {{ϵ}^{`}}_{θ} ( {z}_{t} , t \{ {c}_{s} , {c}_{im} , {c}_{{p}_{a}} \} ) + ⊙ ( 1 - M ) .$$

This indicates that we denoise for target editing (using p_{b}) within the mask and preserve the original image content (using pₐ) outside the mask. When guided by the mask, the first machine learning model 104 can generate an edited image that effectively preserves details (e.g., clothing), compared to the image that is generated with a less precise mask.

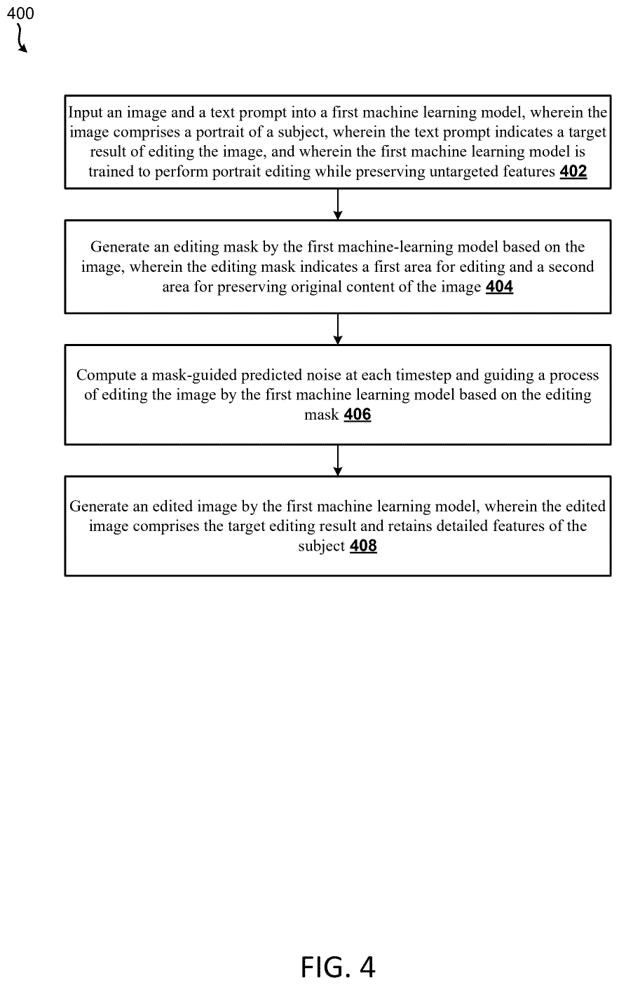

FIG. 4 illustrates an example process 400 for implementing portrait editing using a machine learning model (e.g., the first machine learning model 104) in accordance with the present disclosure. Although depicted as a sequence of operations in FIG. 4, those of ordinary skill in the art will appreciate that various embodiments may add, remove, reorder, or modify the depicted operations.

At 402, an image (e.g., portrait image 102) and a text prompt (e.g., text prompt 103) can be input into a first machine learning model (e.g., the first machine learning model 104). The image can include a portrait of a subject. The text prompt can indicate a target result of editing the image. The first machine learning model can be trained to perform portrait editing while preserving untargeted features in the image.

At 404, an editing mask can be generated. The editing mask can be generated by the first machine-learning model (e.g., the first machine learning model 104). The editing mask can be generated based on the image. The editing mask can indicate a first area for editing. The editing mask can indicate a second area for preserving original content of the image. The editing mask can provide guidance for the first machine learning model during the inference process to keep certain features of the image (e.g., those features in the second area) untouched.

At 406, a mask-guided predicted noise can be computed at each timestep. A process of editing the image by the first machine learning model can be guided based on the editing mask. At 408, an edited image (e.g., edited image 108) can be generated. The edited image can be generated by the first machine learning model. The edited image can include or depict the target editing result. The edited image can retain detailed features of the subject.

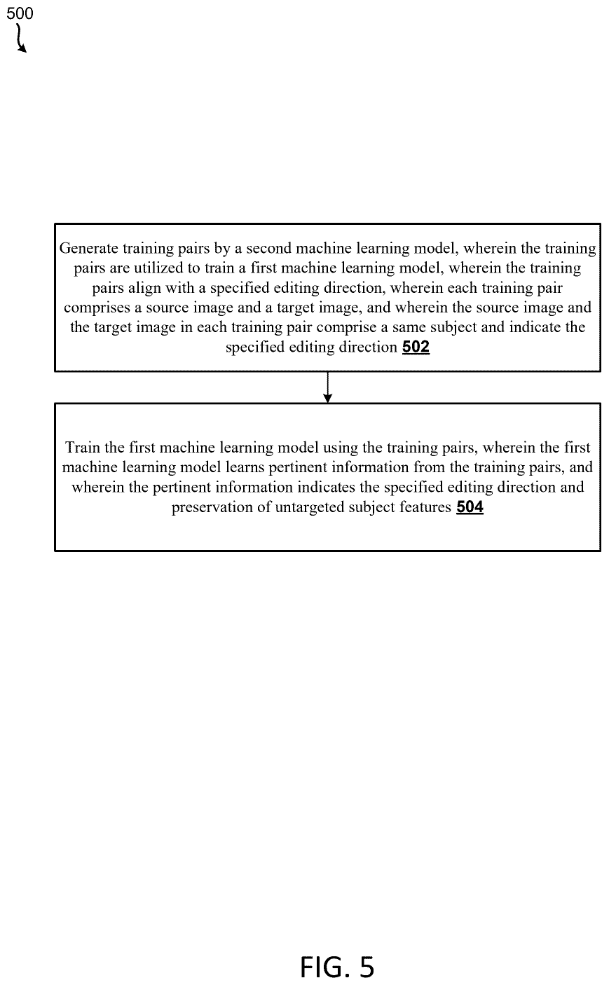

FIG. 5 shows an example process 500 for training a machine learning model in accordance with the present disclosure. Although depicted as a sequence of operations in FIG. 5, those of ordinary skill in the art will appreciate that various embodiments may add, remove, reorder, or modify the depicted operations.

At 502, training pairs can be generated. The training pairs can be generated by a second machine learning model (e.g., the second machine learning model 204). The training pairs can be utilized to train a first machine learning model (e.g., the first machine learning model 104). The training pairs can align with any specified editing direction. The specified editing direction can be, for example, “from a graduation hat to a flat cap hat.” The specified editing direction can be defined by text prompts. Each training pair can include a source image (e.g., x_{A}) and a target image (e.g., x_{B}). The source image and the target image in each training pair include the same subject and indicate the specified editing direction.

At 504, the first machine learning model can be trained. The first machine learning model can be trained using the training pairs generated by the second machine learning model. For example, the first machine learning model can comprise a multi-conditioned diffusion model that is trained on the generated training pairs. The first machine learning model can learn pertinent information from the training pairs. The pertinent information indicates the specified editing direction and preservation of untargeted subject features. By leveraging multiple conditions in different ways, the first machine learning model can effectively learn the editing direction from the training pairs, while preserving detailed subject features that are not supposed to be changed. During inference, the trained first machine learning model can generate edited results using an automatically generated editing mask to further preserve subject details in the input portrait image.

FIG. 6 shows an example process 600 for generating training pairs for training a machine learning model (e.g., the first machine learning model 104) in accordance with the present disclosure. Although depicted as a sequence of operations in FIG. 6, those of ordinary skill in the art will appreciate that various embodiments may add, remove, reorder, or modify the depicted operations.

A second machine learning model (e.g., the second machine learning model 204) can utilize a conditional pair generation strategy built on top of composable diffusion to generate training pairs. At 602, each training pair can be generated through a single denoising process. Each training pair can be generated through the single denoising process by the second machine learning model to enhance identity consistency in a source image (e.g., x_{A}) and a target image (e.g., x_{B}) of each training pair.

To ensure that the second machine learning model can generate x_{A} and x_{B} within a single image through the single denoising process, pretrained stable diffusion can be employed in conjunction with the composable diffusion to generate an image x=[x_{A}, x_{B}]∈R^{H×2W×3}, where the operator [⋅, ⋅] represents the horizontal concatenation of two images. H and W denote the height and width of x_{A} and x_{B}. At 604, a single image can be generated by the single denoising process. The single image can be a horizontal concatenation of the source image and the target image.

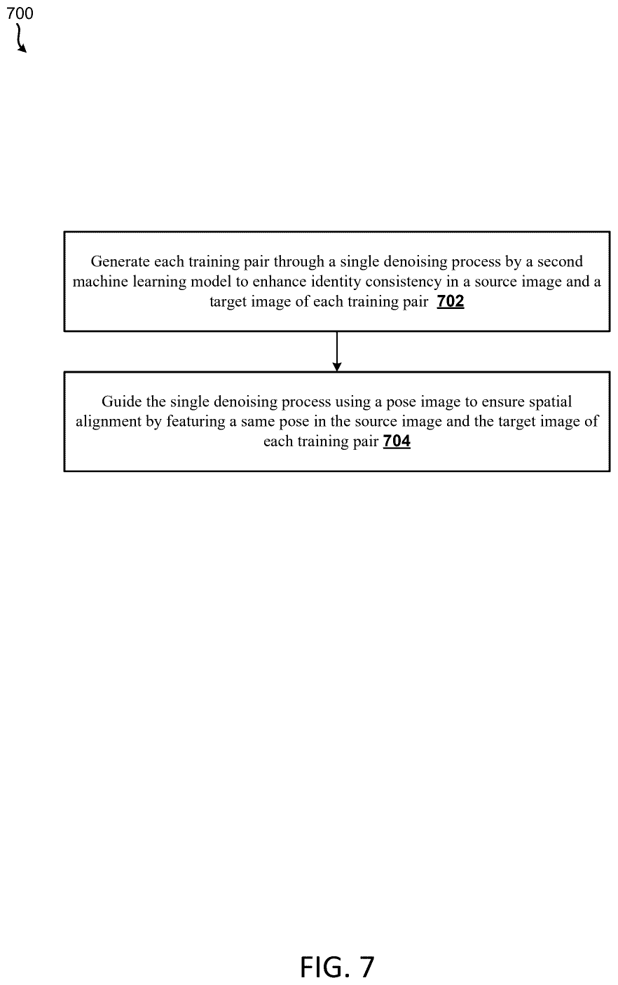

FIG. 7 shows an example process 700 for generating training pairs for training a machine learning model (e.g., the first machine learning model 104) in accordance with the present disclosure. Although depicted as a sequence of operations in FIG. 7, those of ordinary skill in the art will appreciate that various embodiments may add, remove, reorder, or modify the depicted operations.

A second machine learning model (e.g., the second machine learning model 204) can utilize a conditional pair generation strategy built on top of composable diffusion to generate training pairs. At 702, each training pair can be generated through a single denoising process. Each training pair can be generated through the single denoising process by the second machine learning model to enhance identity consistency in a source image (e.g., x_{A}) and a target image (e.g., x_{B}) of each training pair. The second machine learning model can incorporate pose information to improve spatial alignment of the training pairs. At 704, the single denoising process can be guided using a pose image. Guiding the single denoising process using a pose image can include featuring a same pose in the source image and the target image of each training pair. Guiding the single denoising process using a pose image can ensure spatial alignment.

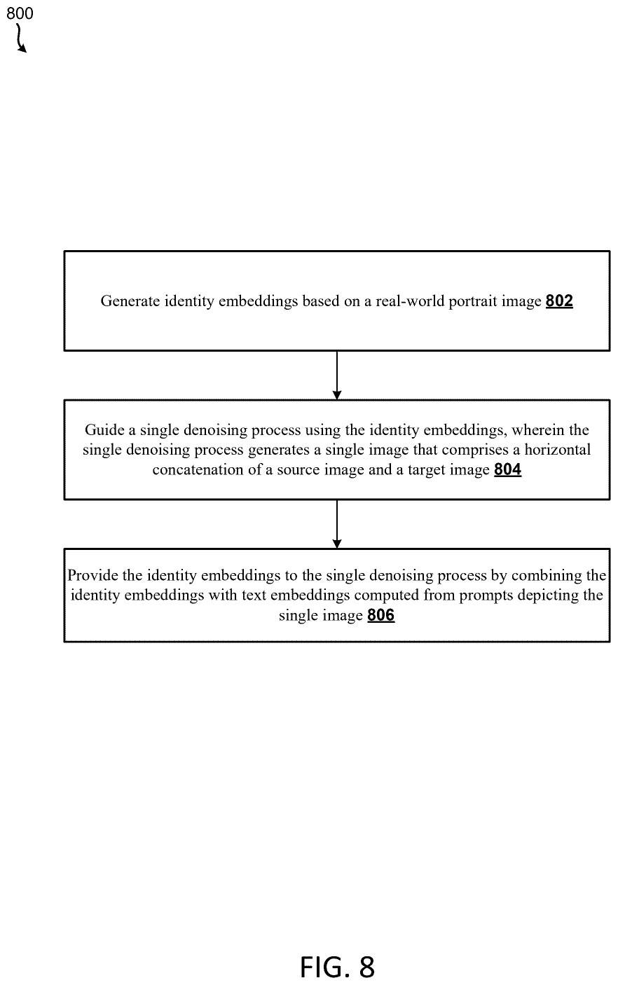

FIG. 8 shows an example process 800 for generating training data for training a machine learning model (e.g., the first machine learning model 104) in accordance with the present disclosure. Although depicted as a sequence of operations in FIG. 8, those of ordinary skill in the art will appreciate that various embodiments may add, remove, reorder, or modify the depicted operations.

At 802, identity embeddings (e.g., c_{id}) can be generated. The identity embeddings can be generated based on a real-world portrait image. The identity embeddings can be extracted from a real-world portrait image. The identity embeddings can be extracted from a real-world portrait image using a variant of CLIP-based identity encoder. This encoder can translate an image into multiple textual word embeddings, and thus can be combined with cₚ, cₚ_{ₐ}, and cₚ_{_{b}} to provide identity information for the denoising process. The cₚ, cₚ_{ₐ}, and cₚ_{_{b}} represent text embeddings computed from the shared prompt p, the source prompt pₐ, and the target prompt p_{b}, respectively. In the example of FIG. 2, p is “the same man on the left and right”, pₐ is “a man, graduation hat”, and p_{b} is “a man, flat cap hat.”

To ensure that the second machine learning model can generate x_{A} and x_{B} within a single image through a single denoising process, pretrained stable diffusion can be employed in conjunction with the composable diffusion to generate an image x=[x_{A}, x_{B}]∈R^{H×2W×3}, where the operator [⋅, ⋅] represents the horizontal concatenation of two images. H and W denote the height and width of x_{A} and x_{B}. At 804, a single denoising process can be guided using the identity embeddings. The single denoising process can generate a single image. The single image can be a horizontal concatenation of the source image and the target image. At 806, the identity embeddings can be provided to the single denoising process. The identity embeddings can be provided to the single denoising process by combining the identity embeddings with text embeddings computed from prompts depicting the single image (e.g., a horizontal concatenation of the source image and the target image).

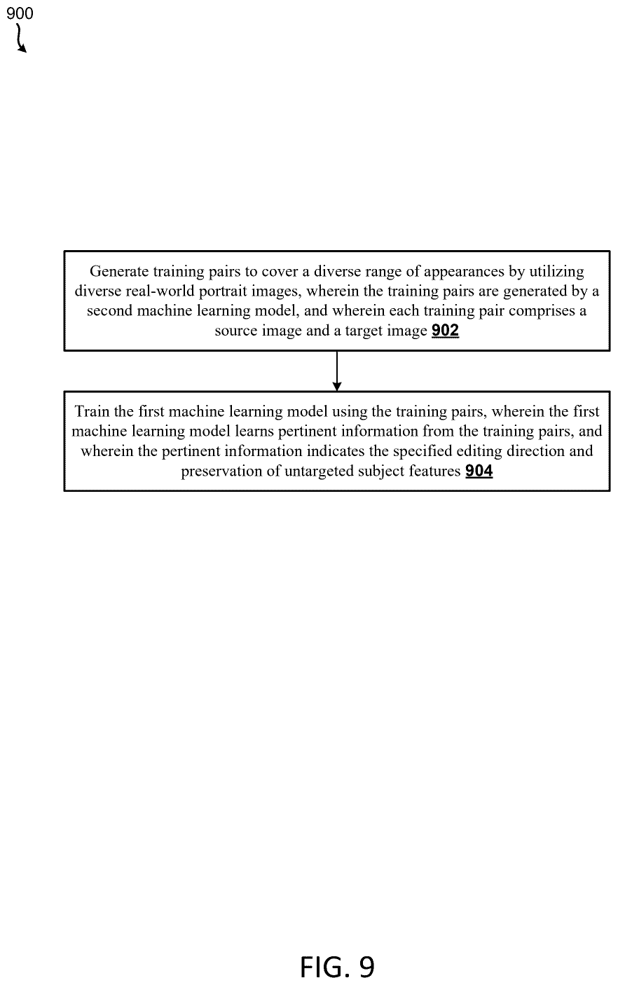

FIG. 9 shows an example process 900 for training a machine learning model in accordance with the present disclosure. Although depicted as a sequence of operations in FIG. 9, those of ordinary skill in the art will appreciate that various embodiments may add, remove, reorder, or modify the depicted operations.

A second machine learning model (e.g., the second machine learning model 204) can produce training pairs aligned with any specified editing directions (e.g., from a graduation hat to a flat cap hat) defined by text prompts. The training pairs can cover a diverse range of user appearances for better generalization. At 902, training pairs can be generated. The training pairs can be generated to cover a diverse range of appearances. The training pairs can be generated by utilizing diverse real-world portrait images. The training pairs can be generated by the second machine learning model. Each training pair can include a source image and a target image.

At 904, a first machine learning model (e.g., the first machine learning model 104) can be trained. The first machine learning model can be trained using the training pairs. For example, the first machine learning model can comprise a multi-conditioned diffusion model that is trained on the training pairs. The first machine learning model can learn pertinent information from the training pairs. The pertinent information indicates the specified editing direction and preservation of untargeted subject features. By leveraging multiple conditions in different ways, the first machine learning model can effectively learn the editing direction from the training pairs, while preserving detailed subject features that are not supposed to be changed. During inference, the trained first machine learning model can generate edited results using an automatically generated editing mask to further preserve subject details in the input portrait image.

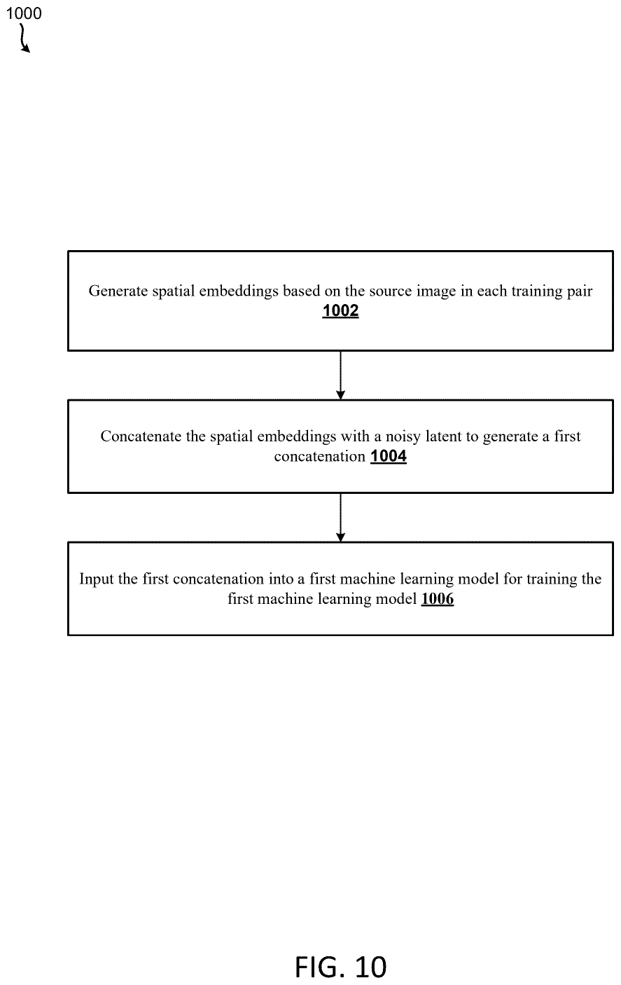

FIG. 10 shows an example process 1000 for generating training pairs for training a machine learning model in accordance with the present disclosure. Although depicted as a sequence of operations in FIG. 10, those of ordinary skill in the art will appreciate that various embodiments may add, remove, reorder, or modify the depicted operations.

At 1002, spatial embeddings (e.g., cₛ) can be generated. The spatial embeddings can be generated based on the source image in each training pair. At 1004, the spatial embeddings can be concatenated with a noisy latent. Concatenating the spatial embeddings with a noisy latent can generate a first concatenation. The resulting concatenation can then be utilized as the input for the U-Net. At 1006, the first concatenation can be input into a first machine learning model (e.g., the first machine learning model 104) for training the first machine learning model.

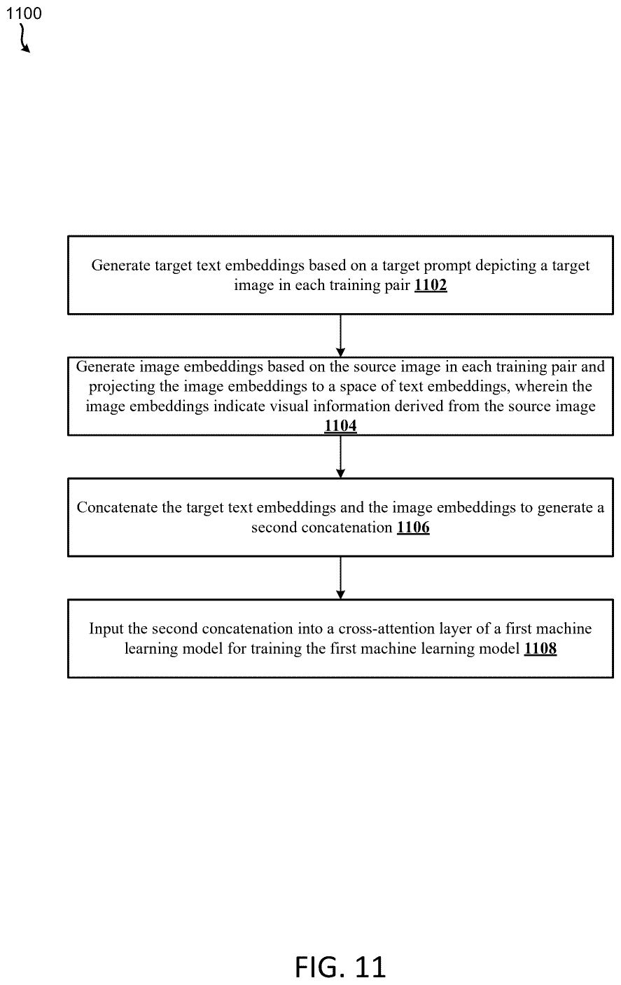

FIG. 11 shows an example process 1100 for training a machine learning model in accordance with the present disclosure. Although depicted as a sequence of operations in FIG. 11, those of ordinary skill in the art will appreciate that various embodiments may add, remove, reorder, or modify the depicted operations.

At 1102, target text embeddings can be generated. The target text embedding can be generated based on a target prompt. The target prompt can depict a target image in each training pair. At 1104, image embeddings can be generated. The image embeddings can be generated based on the source image in each training pair. The image embeddings can be projected to a space of text embeddings. The image embeddings can indicate visual information derived from the source image. At 1106, the target text embeddings and the image embeddings can be concatenated. Concatenating target text embeddings and the image embeddings can generate a second concatenation. At 1108, the second concatenation can be input into a cross-attention layer of a first machine learning model (e.g., the first machine learning model 104) for training the first machine learning model.

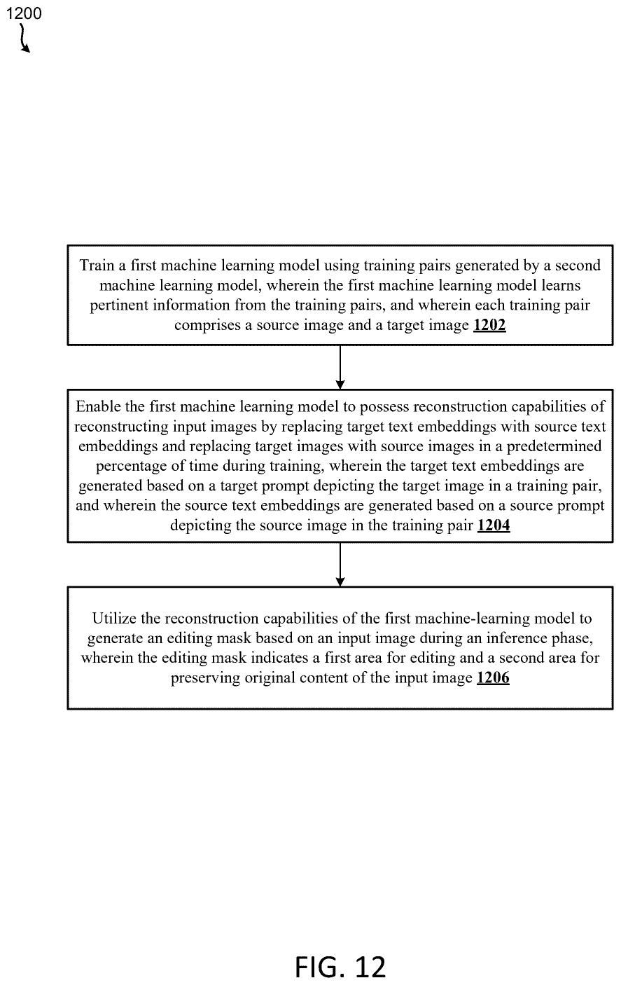

FIG. 12 shows an example process 1200 for enabling a machine learning model to possess reconstruction capabilities and utilizing the reconstruction capability to generate an editing mask in accordance with the present disclosure. Although depicted as a sequence of operations in FIG. 12, those of ordinary skill in the art will appreciate that various embodiments may add, remove, reorder, or modify the depicted operations.

At 1202, a first machine learning model (e.g., the first machine learning model 104) can be trained. The first machine learning model can be trained using training pairs generated by a second machine learning model (e.g., the second machine learning model 204). For example, the first machine learning model can comprise a multi-conditioned diffusion model that is trained on the training pairs. The first machine learning model can learn pertinent information from the training pairs. The pertinent information indicates the specified editing direction and preservation of untargeted subject features. By leveraging multiple conditions in different ways, the first machine learning model can effectively learn the editing direction from the training pairs, while preserving detailed subject features that are not supposed to be changed.

At 1204, the first machine learning model can be enabled to possess reconstruction capabilities of reconstructing input images by replacing target text embeddings with source text embeddings and replacing target images with source images in a predetermined percentage of time during training. The target text embeddings can be generated based on a target prompt depicting the target image in a training pair. The source text embeddings can be generated based on a source prompt depicting the source image in the training pair. The predetermined percentage of time can be, for example, 5% of the time. This enables the first machine learning model to reconstruct input images, which can be utilized during the inference phase for mask generation.

At 1206, the reconstruction capabilities of the first machine-learning model can be utilized to generate an editing mask. The reconstruction capabilities of the first machine-learning model can be utilized to generate an editing mask based on an input image during an inference phase. The editing mask can indicate a first area for editing. The editing mask can indicate a second area for preserving original content of the input image.

The performance of the first machine learning model 104 and the performance of the training data generation pipeline of the second machine learning model 204 were evaluated. The performance of these two pipelines was evaluated for two distinct portrait editing tasks: costume editing and cartoon expression editing. For each task, four different editing directions for input were defined in a specific domain. For costume editing, the input image is a realistic portrait image with everyday costume, and the output is the same person with flower, sheep, Santa Claus, or royal costume. For cartoon expression editing, the input image is a cartoon portrait with a neutral expression, while the output is the same cartoon character with four different expressions: angry, shocked, laughing, or crying. For each task, a dataset of 69,900 image pairs (17475 for each editing direction) was generated for training.

Six state-of-the-art image editing techniques were chosen as baselines for comparison. In particular, Prompt2Prompt (P2P for short), pix2pix-zero, DiffEdit, and SDEdit were selected as baselines. These four state-of-the-art image editing techniques are training-free diffusion methods with editing direction guided by text prompt. Since SDEdit is sensitive to a strength parameter, two different parameters of SDEdit were tested, namely SDEdit 0.5 and SDEdit 0.8. Larger strength produces outputs that obeys the editing directions but deviates from the input images. SPADE and BBDM, which are training-based image editing frameworks building on top of Generative Adversarial Networks and diffusion model, respectively, were also selected as baselines.

Both training-based and training-free methods, when applied to a first scenario revolving around real portrait costume editing, yield unsatisfactory results; the former exhibits noticeable artifacts, while the latter often fails to align with the provided prompts. For a sticker pack generation objective, the objective is to generate a cartoon sticker pack based on an in-the-wild portrait image. To achieve this, data augmentation is initially performed, incorporating processes such as cropping and homography, on the real input image. These augmented data can then be employed to train a model, such as DreamBooth. Subsequently, the trained model can be utilized to generate a cartoonized portrait image of the subject, guided by a meticulously crafted text prompt. Finally, the model described herein is applied to the cartoonized image to produce outputs featuring four distinct trained expressions. Directly utilizing DreamBooth to generate images with various expressions does not yield satisfactory results due to the layout change and overfitting issues. Training-free baselines outperform their training-based counterparts. This is because the training-based baselines are not robust enough to handle imperfect training pairs. In contrast, the method described herein outperforms all baselines in both editing fidelity and the preservation of the subject's features, while maintaining high image quality.

A user study was conducted on two real-world applications, each with twelve examples. Participants were presented with inputs and outputs generated by DiffEdit, SDEdit 0.5, SPADE, BBDM, and the pipeline described herein, randomly shuffled. The 32 participants were asked to give a rating from one to five (higher means better) for each output. The rating of each example and user was normalized to remove the user bias. In the costume editing task, the method described herein achieves the highest average rating, surpassing DiffEdit by 3.3 times, SDEdit 0.5 by 1.8 times, SPADE by 2.1 times, and BBDM by 2.5 times. Similarly, for the expression editing, the method described herein receives the best rating, outperforming DiffEdit by 1.7 times, SDEdit 0.5 by 1.4 times, SPADE by 2.9 times, and BBDM by 1.6 times. These results demonstrate that the method described herein consistently produces superior visual outcomes compared with baselines in both tasks.

For a quantitative evaluation, a validation dataset was created for each task by generating 1,000 image pairs in two distinct ways. The first approach involves generating paired data following the same methodology described before, resulting in 100 pairs. For the second method, a different strategy aimed at introducing subjects not present in the FFHQ dataset was used. Identity embeddings were excluded and detailed text descriptions of individuals were added (generated by ChatGPT) to p, pₐ, and p_{b}. This yields an additional 900 pairs for evaluation.

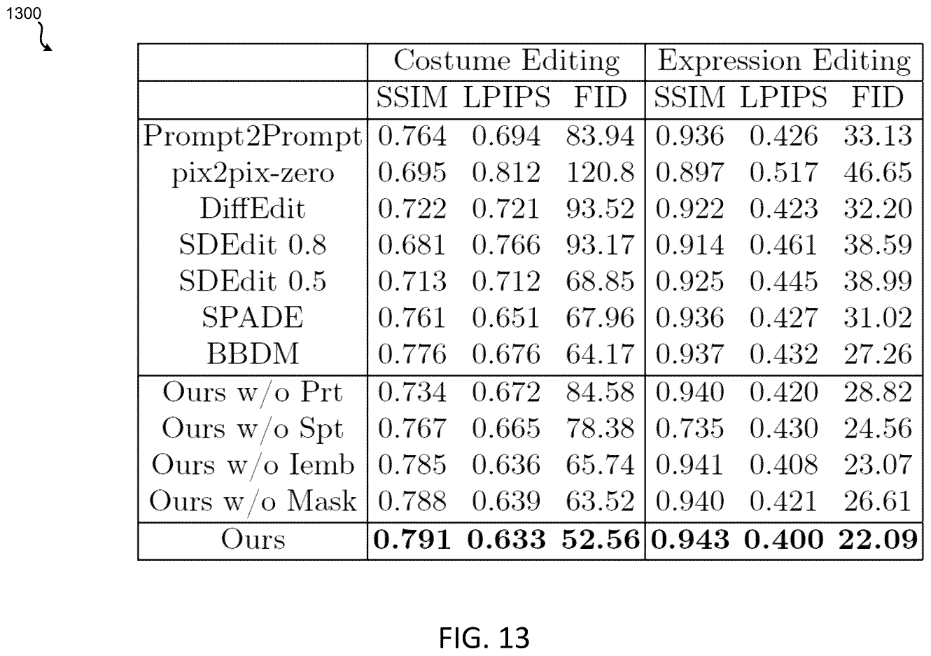

The table 1300 of FIG. 13 shows that the method described herein outperforms all tested baselines. FIG. 13 shows a table 1300 illustrating quantitative results of all tested methods, where the method described herein outperforms all tested baselines and variants over all metrics. When compared on a validation set, the training-free baselines fall short of achieving the intended edits, while the training-based methods exhibit noticeable artifacts on eyes. In contrast, the method described herein produces high-quality editing results while preserving the identity.

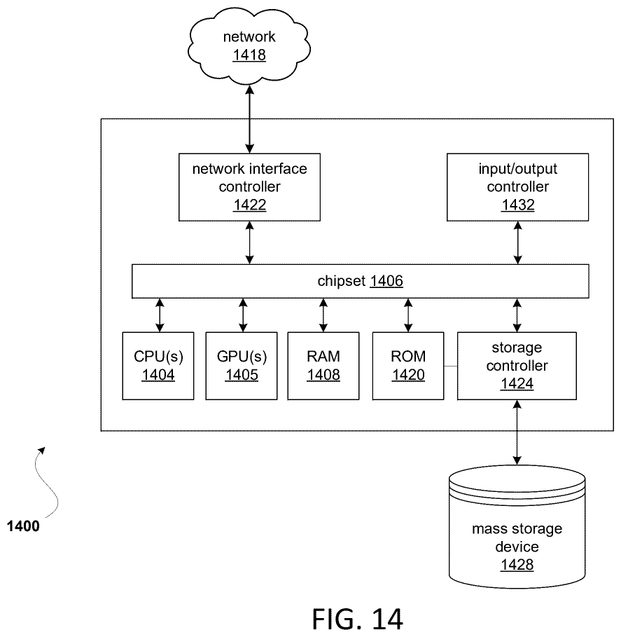

FIG. 14 illustrates a computing device that may be used in various aspects, such as the model(s), components, and/or devices depicted in FIGS. 1-3. With regard to FIGS. 1-3, any or all of the components may each be implemented by one or more instance of a computing device 1400 of FIG. 14. The computer architecture shown in FIG. 14 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1400 may include a baseboard, or “motherboard,” which is a printed circuit board to which a multitude of components or devices may be connected by way of a system bus or other electrical communication paths. One or more central processing units (CPUs) 1404 may operate in conjunction with a chipset 1406. The CPU(s) 1404 may be standard programmable processors that perform arithmetic and logical operations necessary for the operation of the computing device 1400.

The CPU(s) 1404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1404 may be augmented with or replaced by other processing units, such as GPU(s) 1405. The GPU(s) 1405 may comprise processing units specialized for but not necessarily limited to highly parallel computations, such as graphics and other visualization-related processing.

A chipset 1406 may provide an interface between the CPU(s) 1404 and the remainder of the components and devices on the baseboard. The chipset 1406 may provide an interface to a random-access memory (RAM) 1408 used as the main memory in the computing device 1400. The chipset 1406 may further provide an interface to a computer-readable storage medium, such as a read-only memory (ROM) 1420 or non-volatile RAM (NVRAM) (not shown), for storing basic routines that may help to start up the computing device 1400 and to transfer information between the various components and devices. ROM 1420 or NVRAM may also store other software components necessary for the operation of the computing device 1400 in accordance with the aspects described herein.

The computing device 1400 may operate in a networked environment using logical connections to remote computing nodes and computer systems through local area network (LAN). The chipset 1406 may include functionality for providing network connectivity through a network interface controller (NIC) 1422, such as a gigabit Ethernet adapter. A NIC 1422 may be capable of connecting the computing device 1400 to other computing nodes over a network 1416. It should be appreciated that multiple NICs 1422 may be present in the computing device 1400, connecting the computing device to other types of networks and remote computer systems.

The computing device 1400 may be connected to a mass storage device 1428 that provides non-volatile storage for the computer. The mass storage device 1428 may store system programs, application programs, other program modules, and data, which have been described in greater detail herein. The mass storage device 1428 may be connected to the computing device 1400 through a storage controller 1424 connected to the chipset 1406. The mass storage device 1428 may consist of one or more physical storage units. The mass storage device 1428 may comprise a management component 1410. A storage controller 1424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1400 may store data on the mass storage device 1428 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1428 is characterized as primary or secondary storage and the like.

For example, the computing device 1400 may store information to the mass storage device 1428 by issuing instructions through a storage controller 1424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1400 may further read information from the mass storage device 1428 by detecting the physical states or characteristics of one or more particular locations within the physical storage units.

In addition to the mass storage device 1428 described above, the computing device 1400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1400.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1428 depicted in FIG. 14, may store an operating system utilized to control the operation of the computing device 1400. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1428 may store other system or application programs and data utilized by the computing device 1400.

The mass storage device 1428 or other computer-readable storage media may also be encoded with computer-executable instructions, which, when loaded into the computing device 1400, transforms the computing device from a general-purpose computing system into a special-purpose computer capable of implementing the aspects described herein. These computer-executable instructions transform the computing device 1400 by specifying how the CPU(s) 1404 transition between states, as described above. The computing device 1400 may have access to computer-readable storage media storing computer-executable instructions, which, when executed by the computing device 1400, may perform the methods described herein.

A computing device, such as the computing device 1400 depicted in FIG. 14, may also include an input/output controller 1432 for receiving and processing input from a number of input devices, such as a keyboard, a mouse, a touchpad, a touch screen, an electronic stylus, or other type of input device. Similarly, an input/output controller 1432 may provide output to a display, such as a computer monitor, a flat-panel display, a digital projector, a printer, a plotter, or other type of output device. It will be appreciated that the computing device 1400 may not include all of the components shown in FIG. 14, may include other components that are not explicitly shown in FIG. 14, or may utilize an architecture completely different than that shown in FIG. 14.

As described herein, a computing device may be a physical computing device, such as the computing device 1400 of FIG. 14. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of implementing portrait editing using a machine learning model, comprising:
inputting an image and a text prompt into a first machine learning model, wherein the image comprises a portrait of a subject, wherein the text prompt indicates a target result of editing the image, and wherein the first machine learning model is trained to perform portrait editing while preserving untargeted features;
generating an editing mask by the first machine-learning model based on the image, wherein the editing mask indicates a first area for editing and a second area for preserving original content of the image;
computing a mask-guided predicted noise at each timestep and guiding a process of editing the image by the first machine learning model based on the editing mask; and
generating an edited image by the first machine learning model, wherein the edited image comprises the target editing result and retains detailed features of the subject.

2. The method of claim 1, further comprising:
generating training pairs by a second machine learning model, wherein the training pairs are utilized to train the first machine learning model, wherein the training pairs align with a specified editing direction, wherein each training pair comprises a source image and a target image, and wherein the source image and the target image in each training pair comprise a same subject and indicate the specified editing direction.

3. The method of claim 2, further comprising:
generating each training pair through a single denoising process by the second machine learning model to enhance identity consistency in the source image and the target image; and
generating a single image by the single denoising process, wherein the single image comprises a horizontal concatenation of the source image and the target image.

4. The method of claim 3, further comprising:
guiding the single denoising process using a pose image to ensure spatial alignment by featuring a same pose in a left and right parts of the single image.

5. The method of claim 3, further comprising:
generating identity embeddings based on a real-world portrait image; and
guiding the single denoising process using the identity embeddings.

6. The method of claim 5, further comprising:
providing the identity embeddings to the single denoising process by combining the identity embeddings with text embeddings computed from prompts depicting the single image.

7. The method of claim 2, further comprising:
generating the training pairs to cover a diverse range of appearances by utilizing diverse real-world portrait images.

8. The method of claim 2, further comprising:
training the first machine learning model using the training pairs, wherein the first machine learning model learns pertinent information from the training pairs, and wherein the pertinent information indicates the specified editing direction and preservation of untargeted subject features.

9. The method of claim 8, further comprising:
generating spatial embeddings based on the source image in each training pair;
concatenating the spatial embeddings with a noisy latent to generate a first concatenation; and
inputting the first concatenation into the first machine learning model.

10. The method of claim 9, further comprising:
generating target text embeddings based on a target prompt depicting the target image in each training pair;
generating image embeddings based on the source image in each training pair and projecting the image embeddings to a space of text embeddings, wherein the image embeddings indicate visual information derived from the source image;
concatenating the target text embeddings and the image embeddings to generate a second concatenation; and
inputting the second concatenation into a cross-attention layer of the first machine learning model.

11. The method of claim 10, further comprising:
enabling the first machine learning model to possess reconstruction capabilities of reconstructing input images by replacing the target text embeddings with source text embeddings and replacing the target image with the source image in a predetermined percentage of time during training, wherein the source text embeddings are generated based on a source prompt depicting the source image in each training pair, and wherein the reconstruction capabilities of the first machine learning model is utilized during an inference phase for mask generation.

12. A system of implementing portrait editing using a machine learning model, comprising:
at least one processor; and
at least one memory communicatively coupled to the at least one processor and comprising computer-readable instructions that upon execution by the at least one processor cause the at least one processor to perform operations comprising:
inputting an image and a text prompt into a first machine learning model, wherein the image comprises a portrait of a subject, wherein the text prompt indicates a target result of editing the image, and wherein the first machine learning model is trained to perform portrait editing while preserving untargeted features;
generating an editing mask by the first machine-learning model based on the image, wherein the editing mask indicates a first area for editing and a second area for preserving original content of the image;
computing a mask-guided predicted noise at each timestep and guiding a process of editing the image by the first machine learning model based on the editing mask; and
generating an edited image by the first machine learning model, wherein the edited image comprises the target editing result and retains detailed features of the subject.

13. The system of claim 12, the operations further comprising:
generating training pairs by a second machine learning model, wherein the training pairs are utilized to train the first machine learning model, wherein the training pairs align with a specified editing direction, wherein each training pair comprises a source image and a target image, and wherein the source image and the target image in each training pair comprise a same subject and indicate the specified editing direction.

14. The system of claim 13, the operations further comprising:
generating each training pair through a single denoising process by the second machine learning model to enhance identity consistency in the source image and the target image; and
generating a single image by the single denoising process, wherein the single image comprises a horizontal concatenation of the source image and the target image.

15. The system of claim 13, the operations further comprising:
training the first machine learning model using the training pairs, wherein the first machine learning model learns pertinent information from the training pairs, and wherein the pertinent information indicates the specified editing direction and preservation of untargeted subject features.

16. The system of claim 15, the operations further comprising:
generating spatial embeddings based on the source image in each training pair;
concatenating the spatial embeddings with a noisy latent to generate a first concatenation;
generating target text embeddings based on a target prompt depicting the target image in each training pair;
generating image embeddings based on the source image in each training pair and projecting the image embeddings to a space of text embeddings;
concatenating the target text embeddings and the image embeddings to generate a second concatenation; and
inputting the first concatenation and the second concatenation into the first machine learning model.

17. A non-transitory computer-readable storage medium, storing computer-readable instructions that upon execution by a processor cause the processor to implement operations comprising:
inputting an image and a text prompt into a first machine learning model, wherein the image comprises a portrait of a subject, wherein the text prompt indicates a target result of editing the image, and wherein the first machine learning model is trained to perform portrait editing while preserving untargeted features;
generating an editing mask by the first machine-learning model based on the image, wherein the editing mask indicates a first area for editing and a second area for preserving original content of the image;
computing a mask-guided predicted noise at each timestep and guiding a process of editing the image by the first machine learning model based on the editing mask; and
generating an edited image by the first machine learning model, wherein the edited image comprises the target editing result and retains detailed features of the subject.

18. The non-transitory computer-readable storage medium of claim 17, the operations further comprising:
generating training pairs by a second machine learning model, wherein the training pairs are utilized to train the first machine learning model, wherein the training pairs align with a specified editing direction, wherein each training pair comprises a source image and a target image, and wherein the source image and the target image in each training pair comprise a same subject and indicate the specified editing direction.

19. The non-transitory computer-readable storage medium of claim 18, the operations further comprising:
generating each training pair through a single denoising process by the second machine learning model to enhance identity consistency in the source image and the target image; and
generating a single image by the single denoising process, wherein the single image comprises a horizontal concatenation of the source image and the target image.

20. The non-transitory computer-readable storage medium of claim 18, the operations further comprising:
generating the training pairs to cover a diverse range of appearances by utilizing diverse real-world portrait images.
